(19) United States
(12) Patent Application Publication
(10) Pub. No.: US 2008/0163727 A1
(43) Pub. Date: Jul. 10, 2008

(54) Open end wrench

(76) Inventor: Tony O. Darien, West Hempstead, NY (US)

Correspondence Address: DILWORTH & BARRESE, LLP, 333 EARLE OVINGTON BLVD., SUITE 702, UNIONDALE, NY, 11553, US

(21) Appl. No.: 12/006,736

(22) Filed: Jan. 4, 2008

Related U.S. Application Data
(60) Provisional application No. 60/878,636, filed on Jan. 5, 2007.

(51) Int. Cl. B25B 13/20

(52) U.S. Cl. 81/185; 81/111

(57) ABSTRACT

An open end wrench includes a body portion including an elongated longitudinal portion defining a longitudinal axis and having an interior space, and an arcuate first jaw portion fixed to one end of the elongated portion; a second arcuate jaw portion pivotally attached to the arcuate first jaw portion and defining a gripping space therebetween for receiving a fastener, said second arcuate jaw portion being pivotally movable between a gripping condition for gripping the fastener when the wrench is turned in one direction and an non-gripping condition for permitting the arcuate second jaw portion to slip around the fastener without gripping when the wrench is turned in an opposite direction; and (c) resilient means longitudinally oriented and positioned in the interior space of the longitudinal portion of the body for biasing the second jaw portion into the closed position.

### CROSS-REFERENCE TO RELATED APPLICATIONS

The present application claims priority to U.S. Provisional application Ser. No. 60/878,636 filed Jan. 5, 2007, entitled “Slip Wrench”, which is herein incorporated by reference.

### BACKGROUND

1. Field of the Invention

The present application is directed to an open end wrench, and particularly to an automatically adjustable open end wrench.

2. Background of the Art

A wrench is a tool used to apply torque to turn fasteners such as nuts, bolts, and the like. Conventional adjustable open-end wrenches generally comprise a base jaw member, which is connected to a handle, and a movable jaw which is mounted upon the base jaw member. Various types of mechanisms have been provided for adjusting the location of the movable jaw member towards and away from the base jaw member and for maintaining it in position after the required distance between the grip portions of the jaw members is selected. One common way of adjusting the position of the movable jaw member is by means of a manually turned screw which moves the movable jaw towards or away from the base jaw member. This type of screw mechanism requires some time and care for properly adjusting the gap between the wrench base and movable jaw grip portions. Frequently, the grips are initially placed too close together or too far apart for a particular size bolt head or nut and, therefore, further careful adjustment is required.

U.S. Pat. No. 4,324,159 to Wrobbel discloses an open end wrench having a pair of opposing jaws which define a wrench opening. One of the jaws is pivotally mounted on the wrench body while the other may be fixed and integral with the wrench body. The pivotal jaw pivots in opposite directions so as to close the wrench opening and engage or drive a nut or bolt head when turned one way and to open the wrench opening and turn freely about the nut or bolt when turned in the opposite way.

U.S. Pat. No. 4,706,528 to Inoue discloses an adjustable wrench having a fixed jaw, an adjustable jaw which is movable to adjust the gripping distance between the fixed jaw and the adjustable jaw, a sliding jaw portion which is provided as a gripping member on either the fixed or the adjustable jaw and serves as a wedge to decrease the gripping distance between both jaws in its sliding in one direction, and a mechanism which automatically returns the sliding jaw portion to its original retracted position.

U.S. Pat. No. 4,833,949 to Piperkovski discloses an adjustable open end wrench formed with a C-shaped base jaw member having an upper base grip forming portion and a lower tongue forming portion which is pivotally connected to an elongated handle. An L-shaped sliding jaw member has a horizontal leg which is slidably guided between the upper and lower portions of the base jaw member.

U.S. Pat. No. 5,307,713 to White discloses a self aligning wrench which includes a protrusion on one face of the wrench head for alignment purposes.

Various other open end wrenches are disclosed, for example, in U.S. Pat. Nos. 4,843,926, 5,018,412, 6,799,493, and 6,952,984.

There is yet need for an adjustable open end wrench which is simple to make and to use.

### SUMMARY

An open end wrench is provided herein which comprises, (a) a body portion including an elongated longitudinal portion defining a longitudinal axis and having an interior space, and an arcuate first jaw portion fixed to one end of the elongated portion; (b) an arcuate second jaw portion pivotally attached to the arcuate first jaw portion and defining a gripping space therebetween for receiving a fastener, said arcuate second jaw portion being movable between a gripping condition for gripping the fastener when the wrench is turned in one direction and an non-gripping condition for permitting the arcuate second jaw portion to slip around the fastener without gripping when the wrench is turned in an opposite direction; and (c) resilient means longitudinally oriented and positioned in the interior space of the longitudinal portion of the body for resiliently biasing the second jaw portion into the gripping condition.

### BRIEF DESCRIPTION OF THE DRAWINGS

Various embodiments are described below with reference to the drawings wherein:

FIG. 1 is a perspective view of the wrench of the present invention;

FIG. 2 is an exploded perspective view of the wrench;

FIG. 3 is a plan view of the wrench;

FIG. 4 is a side elevational view of the wrench;

FIG. 5 is a sectional view of an embodiment of the wrench;

FIG. 6 is a sectional view of an alternative embodiment of the wrench;

FIG. 7 illustrates turning the wrench in a direction which grips a fastener;

FIG. 8 illustrates turning the wrench in a direction which allows the wrench to slip around the fastener;

FIG. 9 illustrates an embodiment of the wrench with an alignment member.

### DETAILED DESCRIPTION OF PREFERRED EMBODIMENT(S)

The present invention is an automatically adjusting open end wrench with a spring loaded pivoting arm which causes the wrench to engage and tighten about a fastener (e.g., a bolt head, screw head or nut typically having a hexagonal or square edge for gripping) when the wrench is turned in one direction, and to slip around the fastener when the wrench is turned in the opposite direction. Various size nuts or bolts can be accommodated for each tool head.

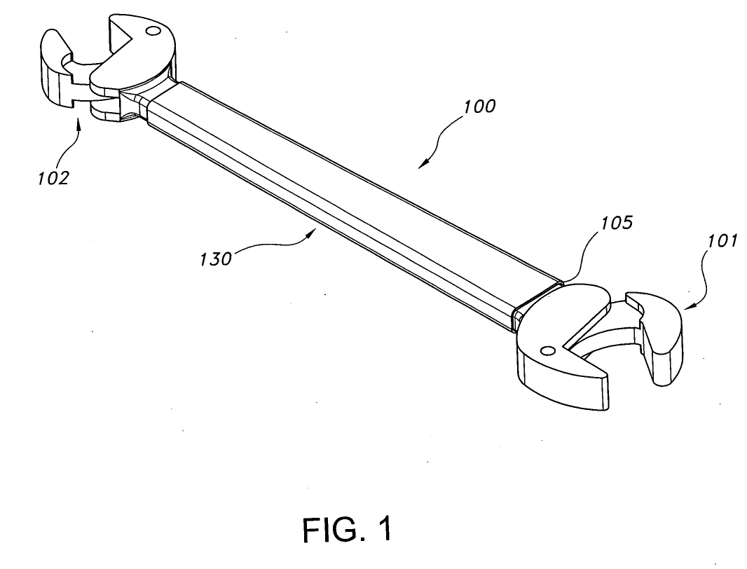

Referring now to FIGS. 1 to 4, the wrench 100 of the invention includes an elongated portion 130, which functions as a handle, and at least one head portion 101 at one end of the elongated portion 130. First head portion 101 is dimensioned so as to accommodate a range of fastener head sizes. Preferably, a second head portion 102 is located at the opposite end of the elongated portion 130 and is of similar construction to the first head portion 101, except that second head portion 102 can be dimensioned so as to accommodate a different range of fastener head sizes. Parts of the second head portion 102 which correspond to the parts of the first head portion 101 are identified in the drawings with the same numerals as the corresponding parts.

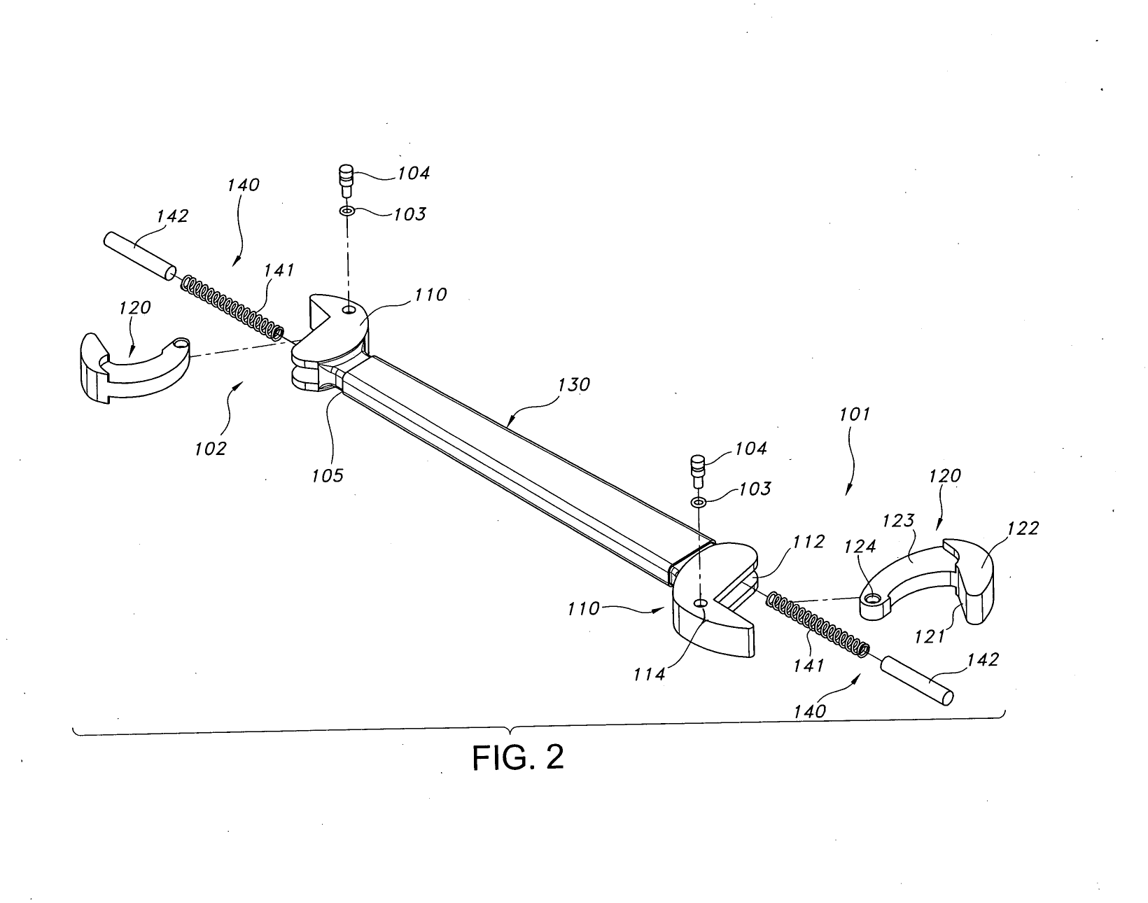

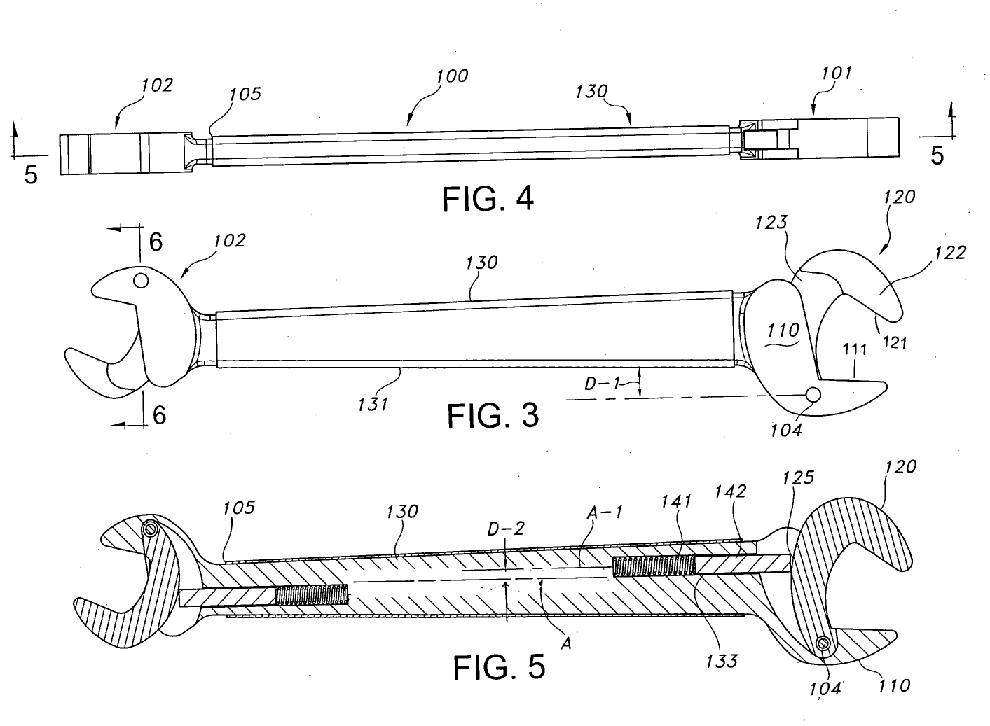

Head portion 101 includes a first jaw portion 110 and a second jaw portion 120. First jaw portion 110 has an arcuate shape and a flat interior edge 111 (FIG. 3) for contacting and gripping a flat surface of, for example, a hexagonal or square edge of a fastener or fastener head. The first jaw portion 110 is fixedly attached to, and preferably of integral, single piece construction with, the elongated portion 130 so as to provide a wrench body. A second jaw portion 120 is pivotally attached to the first jaw portion at a pivot point by pivot pin 104. Pivot pin 104 is secured by means of an O-ring 103 (FIG. 2) and is disposed through aperture 114 of the first jaw portion 110.

Referring to FIG. 3, the elongated portion 130 has an outer longitudinal rectilinear edge 131. The position of the pivot pin 104 is laterally offset outwardly from the outer edge 131 of the elongated portion 130 by a distance D-1, wherein D-1 can be any distance suitable for the operation of the wrench 100 of a particular size. Typically, for commonly sized wrenches, D-1 preferably ranges from about 0.1 to about 0.5 inches, more preferably from about 0.2 to about 0.4 inches, and most preferably from about 0.25 to about 0.35 inches.

Referring to FIGS. 1, 2 and 3, the second jaw portion 120 is an arcuate member having a wide portion 122 with a flat interior edge 121 for contacting and gripping a flat surface of a fastener or fastener head. Flat edges 111 and 121 are in opposing spaced relationship and together define a jaw space therebetween to receive the fastener.

Narrow portion 123 is adapted to be movably engaged within slot 112 (FIG. 2) of the first jaw portion 110. Aperture 124 of the second jaw portion 120 is aligned with aperture 114 of the first jaw portion 110 and also receives pivot pin 104 around which the second jaw portion 120 pivots.

Referring to FIGS. 7 and 8, the second jaw portion 120 is pivotally movable between a gripping condition when the when the wrench is turned in one direction R-1 around the fastener F, and a non-gripping condition when the wrench is turned in the opposite direction R-2. In the gripping condition the second jaw portion 120 tightens around and grips the fastener F to enable it to be turned. In the non-gripping condition, the second jaw portion slips around the fastener F without gripping it.

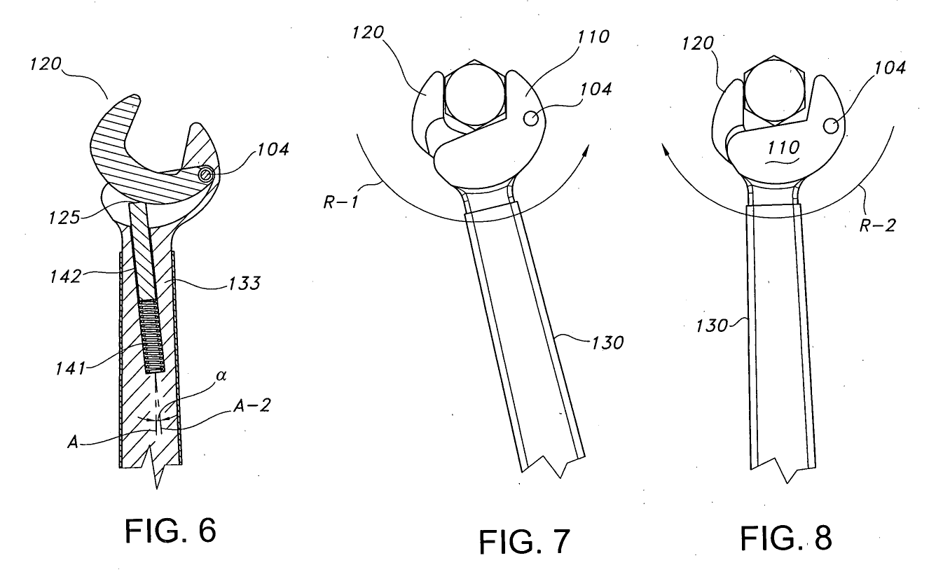

Referring to FIGS. 5 and 6, the elongated longitudinal portion 130 has at least one channel 133 extending longitudinally therethrough in which a resilient biasing means 140 is positioned for biasing the second jaw portion 120 to the gripping condition. The resilient biasing means 140 includes a helical compression spring 141, and a pin 142. The compression spring 141 biases the pin 142 into contact with an edge of the second jaw portion 120.

As shown in FIG. 5, the elongated longitudinal portion 130 includes a longitudinal axis A extending centrally therethrough. Channel 133 and the resilient biasing means 140 are arranged along an axis A-1 which is parallel to, but spaced from central longitudinal axis A by a distance D-2, wherein D-2 can range up to about ¼ inch, and is preferably from 1/32 to about ⅛ inches. Accordingly, pin 142 contacts the edge of the second jaw portion 120 at a point 125 which is offset from the central longitudinal axis A. This arrangement provides more leverage for the alignment means to bias the second jaw portion 120 to the gripping condition.

In another more preferred embodiment of the invention as shown in FIG. 6, the resilient biasing means 140 defines an axis A-2 which is oriented at an angle α from the central longitudinal axis A of the longitudinal portion 130. Angle α can range up to about 15 degrees, and is preferably from about 1 degree to about 8 degrees, and more preferably from about 3 degrees to about 6 degrees. Pin 142 optionally contacts the edge of the second jaw portion 120 at a point 125 which is offset from the central longitudinal axis A. This arrangement also provides more even support for the resilient biasing means 140.

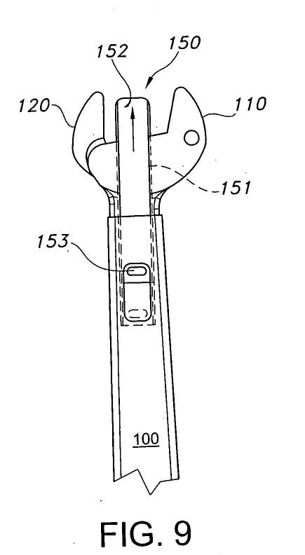

Referring to FIG. 9, the wrench 100 preferably also includes an alignment member 150 which is movable between a longitudinally extended position and a withdrawn position. In the longitudinally extended position alignment member 150 extends over the jaw space so as to abut the end surface of the fastener when the fastener is engaged in the jaws of the wrench. This provides stability so that the head portion of the wrench does not easily slip off the fastener. In one embodiment of the invention the alignment member 150 is an elongated metal strip having beveled longitudinal side edges 151 angled at from about 40 degrees to about 50 degrees so as to retain the metal strip in sliding contact with the wrench body. The alignment member 150 can easily be slidably moved between the withdrawn position wherein the alignment member 150 does not extend over the jaw space of the head portion, and the extended position by the wrench user applying finger pressure to the alignment member surface 152, or more preferably to a projection 153 thereon for receiving finger pressure.

Referring to FIGS. 1 and 5, for example, the wrench optionally includes a polymeric coating 105 covering the elongated portion 130. The polymeric coating can be of any suitable homopolymer or copolymer such as plasticized polyvinylchloride (PVC), polyethylene, polypropylene, ethylene-propylene copolymer, natural and synthetic rubber, and the like. Coating 105 provides cushioning for the hand of the user as well as thermal and/or electrical insulation.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. An open end wrench comprising;
a) a body portion including an elongated longitudinal portion having a central longitudinal axis and having an interior space, and an arcuate first jaw portion fixed to one end of the elongated portion;
b) an arcuate second jaw portion pivotally attached to the arcuate first jaw portion and defining a gripping space therebetween for receiving a fastener, said arcuate second jaw portion being movable between a gripping condition position for gripping the fastener when the wrench is turned in one direction and a non-gripping condition for permitting the arcuate second jaw portion to slip around the fastener without gripping when the wrench is turned in an opposite direction; and
c) resilient means longitudinally oriented and positioned in the interior space of the longitudinal portion of the body for resiliently biasing the second jaw portion into the gripping condition.

2. The open end wrench of claim 1 wherein the resilient means comprises a spring and a pin.

3. The open end wrench of claim 2 wherein the spring is a helical compression spring.

4. The open end wrench of claim 3 wherein an end of the pin abuts a surface of the second jaw portion.

5. The open end wrench of claim 4 wherein the compression spring and the pin of the resilient means are aligned along an axis which is parallel to and laterally offset from the central longitudinal axis of the elongated longitudinal portion.

6. The open end wrench of claim 4 wherein the compression spring and the pin of the resilient means are aligned with an axis which is angled from the longitudinal axis of the longitudinal portion of the body by an angle of up to about 15 degrees.

7. The open end wrench of claim 4 wherein the compression spring and the pin of the resilient means are aligned with an axis which is angled from the longitudinal axis of the longitudinal portion of the body by an angle of from about 1 degree to about 8 degrees.

8. The open end wrench of claim 4 wherein the compression spring and the pin of the resilient means are aligned with an axis which is angled from the longitudinal axis of the longitudinal portion of the body by an angle of from about 3 degrees to about 6 degrees.

9. The open end wrench of claim 1 wherein the second jaw portion is pivotally attached to the arcuate first jaw portion at a pivot point positioned laterally offset from an outer edge of the longitudinal portion of the body.

10. The open end wrench of claim 1 further including an alignment member longitudinally movable between an extended position and a withdrawn position.

11. The open end wrench of claim 10 wherein the alignment member in the extended position extends at least partially over an end surface of a fastener when the fastener is positioned within the gripping space of the wrench.

12. The open end wrench of claim 10 wherein the alignment member comprises a flat metal strip.

13. The open end wrench of claim 12 wherein the flat strip has two longitudinal edges each beveled at an angle of from about 40 degrees to about 50 degrees.

14. The open end wrench of claim 1 wherein the elongated longitudinal portion is coated with a polymeric material.

15. The open end wrench of claim 14 wherein the polymeric material is selected from plasticized polyvinylchloride, polyethylene, polypropylene, ethylene-propylene copolymer, and natural and synthetic rubber.

16. An open end wrench comprising;
a) a handle portion including an elongated longitudinal portion having a central longitudinal axis and having first and second interior channels
b) a first head portion positioned at one end of the handle portion and a second head portion positioned at the opposite end of the handle portion, each of said head portions including an arcuate first jaw portion fixed to the respective end of the handle portion and an arcuate second jaw portion pivotally attached to the arcuate first jaw portion and defining a gripping space therebetween for receiving a fastener, said arcuate second jaw portion being movable between a gripping condition position for gripping the fastener when the wrench is turned in one direction and a non-gripping condition for permitting the arcuate second jaw portion to slip around the fastener without gripping when the wrench is turned in an opposite direction; and
c) first resilient means positioned in the first interior channel of the handle for resiliently biasing the second jaw portion of the first head portion into the gripping condition, and second resilient means positioned in the second interior channel of the handle for resiliently biasing the second jaw portion of the second head portion into the gripping condition.

17. The open end wrench of claim 16 wherein each of the first and second resilient means comprises a compression spring and a pin which abuts a surface of the respective second jaw portion, wherein the compression spring and the pin of the resilient means are aligned with an axis which is angled from the central longitudinal axis of the handle by an angle of up to about 15 degrees.

18. The open end wrench of claim 16 wherein the second jaw portion of each of the first and second head portions is pivotally attached to the respective arcuate first jaw portion at a pivot point positioned laterally offset from a respective outer edge of the longitudinal portion of the body.

19. The open end wrench of claim 16 further including an alignment member longitudinally movable between an extended position and a withdrawn position.

20. The open end wrench of claim 1 wherein the first head portion and the second head portion are differently dimensioned so as to accommodate different respective ranges of fastener sizes.
